(19) United States
(12) Patent Application Publication
(10) Pub. No.: US 2023/0063287 A1
(43) Pub. Date: Mar. 2, 2023

(54) HANDLE INSERT

(71) Applicant: 14th Round Inc., Van Nuys, CA (US)

(72) Inventor: Christopher George Palmer, Van Nuys, CA (US)

(21) Appl. No.: 17/899,039

(22) Filed: Aug. 30, 2022

Related U.S. Application Data
(60) Provisional application No. 63/238,462, filed on Aug. 30, 2021.

(51) Int. Cl. B65D 5/46

(52) U.S. Cl. CPC B65D 5/46024

(57) ABSTRACT

A handle insert secures top and bottom portions of a box or container to one another while providing a point for securely applying a lifting force to the box or container. The handle insert includes first and second anchoring ends connected by a strap, wherein the first and second anchoring ends each comprise a cavity defined by a closed end and a wall that extends from a perimeter of the closed end, wherein the first and second anchoring ends are configured to detachably attach by nesting.

### CROSS-REFERENCE TO RELATED APPLICATIONS

This application claims the priority benefit of U.S. Provisional Application No. 63/238,462 filed on Aug. 30, 2021 and incorporated herein by reference in its entirety.

### FIELD OF THE INVENTION

The present invention relates to inserts for gripping, stabilizing, and/or maneuvering a container. More specifically, the invention relates to handle inserts that retain or fasten together the side walls of top and bottom packaging components for improved stability and ease of carrying.

### BACKGROUND

Packaging holding and carrying mechanisms like plastic clips utilized for telescoping parts generate large amounts of waste. Recycling of this packaging component can be inconsistent, costly and despite many efforts harmful to the environment. Not every non-biodegradable part or packaging component is pulled out into a recycling stream, leaving potentially harmful packaging in landfills or other waste management systems. Efforts towards creating an environmentally efficient packaging clip system that is cost effective, carbon effective and readily recyclable or biodegradable while being secure, functional, and performs in distribution through typical retail logistic chains have been increasing.

Traditionally, many boxes require the use of plastic holding clips to allow for the use and removal of a telescoping lid component that can be released by unlocking the clip. The clip typically protrudes through two or more overlapping planes of a box system, holding the overlapping planes together. Releasing the clip allows the planes, more often a lid and a base structure, to be independent therefore allowing access to the box contents in a telescopic fashion. Unfortunately, most functional iterations of these plastic clips require the full removal of the clip from the complete box structure in order to allow the box to be accessible. It is common to reseal the box structure and many clips are difficult to assemble again, require a precise understanding of functionality and in many instances are discarded before resealing the box. Without the clip the integrity of box structure is compromised. Therefore, in addition to sustainability initiatives it would be of unique utility for any new design to be designed in such a way that it did not have to be removed from box structure completely.

In other embodiments the disclosure provides for example without limitation a through-air dried tissue product comprising bamboo fibers, wherein the bamboo fibers are selected from the group consisting of temperate running bamboos including but not limited to Phyllostachys heterocycla pubescens, Phyllostachys nigra variant Henon, Phyllostachys vivax and Phyllostachys Bambusoides, Phyllostachys edulis, Bambusa vulgaris, and mixtures thereof.

Generally, the bamboo fibers incorporated in the present disclosure are fibrous materials derived from any bamboo species. The bamboo fiber species may be selected from the group consisting of Acidosasa sp., Ampleocalamus sp., Arundinaria sp., Bambusa sp., Bashania sp., Borinda sp., Brachystachyum sp., Cephalostachyum sp., Chimonobambusa sp., Chusquea sp., Dendrocalamus sp., Dinochloa sp., Drepanostachyum sp., Eremitis sp., Fargesia sp., Gaoligongshania sp., Gelidocalamus sp., Gigantocloa sp., Guadua sp., Hibanobambusa sp., Himalayacalamus sp., Indocalamus sp., Indosasa sp., Lithachne sp., Melocanna sp., Menstruocalamus sp., Nastus sp., Neohouzeaua sp., Neomicrocalamus sp., Ochlandra sp., Oligostachyum sp., Olmeca sp., Otatea sp., Oxytenanthera sp., Phyllostachys sp., Pleioblastus sp., Pseudosasa sp., Raddia sp., Rhipidocladum sp., Sasa sp., Sasaella sp., Sasamorpha sp., Schizostachyum sp., Semiarundinaria sp., Shibatea sp., Sinobambusa sp., Thamnocalamus sp., Thyrsostachys sp., Yushania sp., and mixtures thereof.

In some embodiments, the bamboo fiber is from temperate bamboos of the Phyllostachys species, for example Phyllostachys heterocycla pubescens, also known as Moso Bamboo. However, it is to be understood that the compositions disclosed herein are not limited to containing any one bamboo fiber and may comprise a plurality of fibers of different species. For example, the composition may comprise a bamboo from a Phyllostachys heterocycla pubescens and a bamboo from a different species such as, for example, Phyllostachys bambusoides.

In some embodiments, a slurry or molding blend is created for pressing into or against a molding surface, with this slurry including varying degrees of moisture content, known in the art as wet press and dry press methods, among others, and also comprising a portion of sugar cane bagasse or husk. A known and applicable species of sugar canes include Saccharum officinarum, among other species or hybrids, which may form a composite with other fibers such as bamboo, potato starch, or paper pulp in order to optimize durability, strength, surface finish, and cost. The long fibers of bamboo can be important for providing strength, but the blend of the bamboo with other materials is considered to be important for durability and surface finish of the end product. In other embodiments an exemplary handle insert of the sort disclosed herein could be made from recycled paper fibers.

Inserts exist in the prior art, for example, as injection molded articles used for tethering boxes to pallets. Such known inserts are, for example, inserted into cardboard box side walls at a first end and fastened to corresponding pallet features at an opposite second end for restriction of sliding between the pallet and box. Known inserts are used as staples to secure two flaps of a box together. Known inserts are further used as protective pads or armor for the corners or edges of packages that are susceptible to damage from impacts at the corners or edges. Known inserts may also be used to protect box corners or protrusions from wear. Other examples of known inserts include casters affixed to the floor of a carton.

However, what is needed is a handle insert that simply attaches through the handholds of a two-part box or container. It would be advantageous for the handle insert to provide for a lifting force to be applied to the sidewalls of the box or container while simultaneously securing a top portion of the box or container, referred to herein as a box lid, from vertically translating relative to a bottom portion of the box or container, referred to herein as a box bottom. It would be advantageous if the handle insert could be applied to the box or container without a tool, such as for example a staple gun. It would be further advantageous for such a handle insert to have a structure making it suitable for application to boxes or containers of different sizes.

### BRIEF SUMMARY OF THE INVENTION

In an aspect of the invention, a handle insert comprises first and second anchoring ends connected by a strap, wherein the first and second anchoring ends each comprise a cavity defined by a closed end and a wall that extends from a perimeter of the closed end, wherein the first and second anchoring ends are configured to detachably attach by nesting.

In another aspect of the invention, a handle insert comprises first and second anchoring ends connected by a strap, wherein the first and second anchoring ends each comprise a cavity defined by a closed end and a wall that extends from a perimeter of the closed end, wherein the first and second anchoring ends are configured to detachably attach by nesting, and wherein the strap comprises at least two grooves disposed in a surface of the strap, the at least two grooves oriented to extend laterally across the strap.

In a further aspect of the invention, a handle insert comprises first and second anchoring ends connected by a strap, wherein the first and second anchoring ends each comprise a cavity defined by a closed end and a wall that extends from a perimeter of the closed end, wherein the first and second anchoring ends are configured to detachably attach by nesting, and wherein the strap comprises at least two grooves disposed in a surface of the strap, the at least two grooves oriented to extend laterally across the strap.

### BRIEF DESCRIPTION OF THE DRAWINGS

FIG. 1 illustrates an embodiment of an exemplary handle insert in accordance with the present invention;

FIG. 1A illustrates another embodiment of an exemplary handle insert in accordance with the present invention;

FIG. 1B illustrates an exemplary folding of the strap of an exemplary handle insert;

FIG. 2 illustrates a side view of an embodiment of an exemplary handle insert in accordance with the present invention;

FIG. 3 illustrates an assembled box or container including an embodiment of an exemplary handle insert in accordance with the present invention applied thereto;

FIG. 4 illustrates a step in the removal of the exemplary handle insert from the box of FIG. 3;

FIG. 5 illustrates a further step in the removal of the exemplary handle insert from the box of FIG. 3;

FIG. 6 illustrates yet a further step in the removal of the exemplary handle insert from the box of FIG. 3;

FIG. 6A shows an embodiment of a method for applying an exemplary handle insert to a box or container;

FIG. 6B shows an embodiment of a method for removing an exemplary handle insert from a box or container;

FIG. 7 is an enlarged view of a second anchoring end of an embodiment of an exemplary handle insert;

FIG. 8A illustrates another embodiment of an exemplary handle insert having a push through flap in a closed position; and

FIG. 8B illustrates the embodiment of the exemplary handle insert of FIG. 8A showing the push through flap in an open position.

Other aspects and advantages of the present invention will become apparent upon consideration of the following detailed description, wherein similar structures have similar reference numerals.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

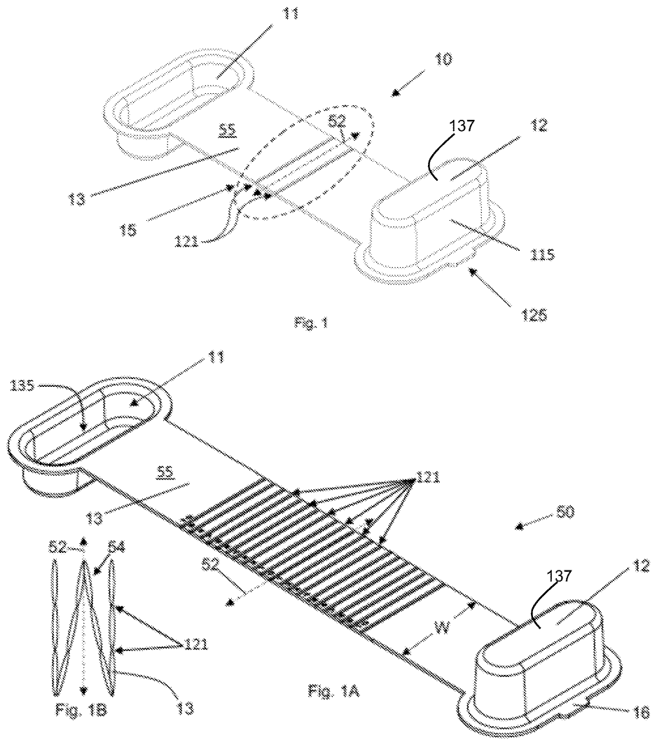

FIG. 1 illustrates an embodiment of a handle insert 10 of the present invention. The handle insert 10 may be fabricated with, for example and without limitation, plastics such as polypropylene or high density polyethylene (HDPE), a paper based material, a biodegradable paper based material, a blend of paper with bagasse or bamboo, naturally occurring fibrous or leafy sheet materials such as for example bamboo, bagasse, cereal straws, sheet metals such as aluminum or steels such as stainless steels, PET laminated steel, or epoxy coated steel, or other substances such as silicone rubber, or from any other suitable material, as is known in the art. The handle insert 10 may be fabricated by any combination of one or more of stamping, casting, molding for example injection molding, reaction injection molding or vacuum molding techniques, stamping, drawing and ironing, cutting, and/or by any other suitable process as is known in the art. Molded polymers/plastics/resins having wood/bamboo pulp fillers are also contemplated.

In one embodiment, the handle insert 10 includes a first anchoring end 11 and a second anchoring end 12 that are connected by a strap 13. The first and second anchoring ends 11, 12 are configured to detachably attach, for example by nesting. In one embodiment for example, the second anchoring end 12 press fits into the first anchoring end 11 to detachably attach thereto. In other embodiments the second anchoring end 12 detachably attaches to the first anchoring end 11 in other ways as may be known in the art, for example without limitation by an adhesive or adhesive tape applied to one or both of the first and second anchoring ends 11, 12, or by a snap fit between the first and second anchoring ends 11, 12 wherein a protruding or recessed feature on one of the first or second anchoring ends 11, 12, snaps into or over a corresponding protruding or recessed feature on the other of the first and second anchoring ends 11, 12 when the second anchoring end 12 is pressed into the first anchoring end 11. Each of the first and second anchoring ends 11, 12 are further configured to detachably attach, for example without limitation by being press fit, through a hole disposed through a sidewall of a top or bottom half of a container, box, or carton (see FIGS. 3-6).

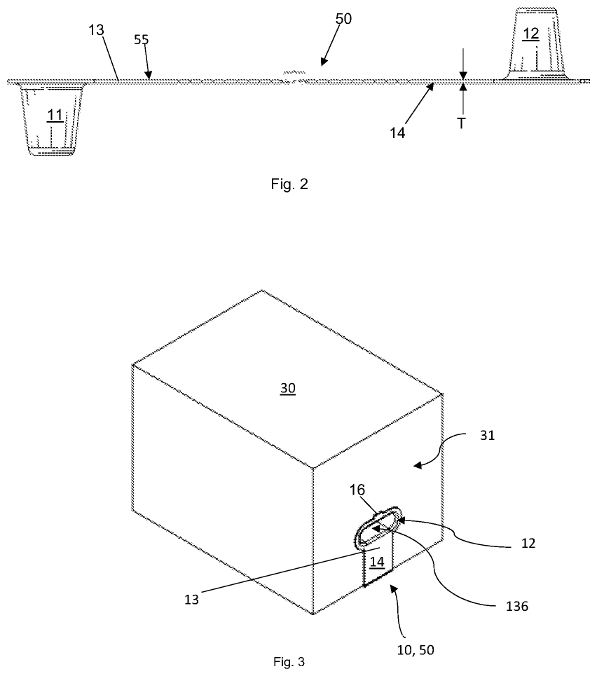

The handle insert 10 includes a pair of scores or grooves 121 in one or both of a top surface 55 and a bottom surface 14 (see FIG. 2) of the strap 13 and about equally spaced from a longitudinal centerline 52 of the strap 13. The pair of scores or grooves 121 is oriented to extend laterally across the strap 13. In one embodiment the pair of scores or grooves 121 are sufficiently deep into the thickness of the strap 13 to provide a bending point or living hinge 15 for the strap 13. In some embodiments the scores or grooves 121 may be for example without limitation creases of a molded product, such as plastic, rubber, bamboo pulp or paper, or a score in a sheet product such as cardboard or paper, or perforations.

In this embodiment of the handle insert 10, the pair of scores or grooves 121 forming the living hinge 15 allow for the handle insert 10 to be folded over for use with boxes of a given handle height. Making the strap 13 different lengths as illustrated by the variable length markings across the strap 13 as shown in FIGS. 1A and 2 allows an embodiment of the handle insert 50 to be manufactured with different strap 13 lengths for use with boxes having different handle heights; however, the handle insert 10 having a single pair of scores or grooves 121 will fit on boxes having only a particular handle height matching the height of the folded handle insert 10.

Referring to FIG. 1A, another embodiment of a handle insert 50 is similar to the handle insert 10 except that the handle insert 50 includes more than two scores or grooves 121 in one or both of the top surface 55 and a bottom surface 14 (see FIGS. 1A and 2) of the strap 13. The more than two scores or grooves 121 are about equally spaced apart from one another and as a group are about centered on the longitudinal centerline 52 of the strap 13. In one embodiment as shown in FIG. 1A, the more than two scores or grooves 121 are labeled with an alphabetic or numeric indicia, for example numbers 1, 2, 3, 4, etc., wherein grooves on either side of the centerline 52 that are labeled with the same alphabetic or numeric indicia are equally spaced from the centerline 52. In one embodiment the more than two scores or grooves 121 are sufficiently deep into the thickness of the strap 13 to provide more than two bending points for the strap 13.

Providing more than two bending points for the strap 13 allows the handle insert 50 to be used with boxes of different handle heights. For example, the handle insert 50 may be bent at the innermost two scores 121 (each marked with a 1 in FIG. 1A) for use with a box of a given handle height. Alternatively, referring to FIG. 1B, the handle insert 50 may be bent, for example, at the 3rd scores 121 on each side of the centerline 52 for use with a box of a shorter handle height. Any excess part 54 of the strap 13 between the folded 3^{rd} scores 121 can be tucked up as shown between the two folded sides beyond the folded 3^{rd} scores 121.

Still referring to FIG. 1A, the second anchoring end 12 is sized and configured to detachably engage the first anchoring end 11, for example without limitation by a press fit. In particular, the second anchoring end 12 nests within a first cavity 135 of the first anchoring end 11. The second anchoring end 12 has a hollow structure that is similar to that of the first anchoring end 11. The second anchoring end 12 includes a second cavity 136 (see FIG. 3) that serves as a hand-hold lifting cavity on an assembled package. The second anchoring end 12 further includes a small tab 16 that is helpful when installing and uninstalling the handle insert 10, 50 as will be described in detail hereinbelow. In an embodiment each of the first and second cavities 135, 136 has a closed end 137 and an open end opposite the closed end 137, and is defined by the closed end 137 and an outer surface or wall 115 that extends from a perimeter of the closed end 137.

FIG. 2 illustrates a side view of the handle insert 50. In some embodiments, the strap 13 of the handle insert 10, 50 is of uniform thickness, T, and uniform width, W (see FIG. 1A); however, in other embodiments, the thickness and/or width of the strap 13 may vary along its length between the first and second anchoring ends 11, 12. Surfaces 55 and/or 14 may be embossed or further incised or printed with indicia or instructions (e.g., “Insert this end first”) as may be known in the art.

FIG. 3 shows a box or container lid member 30 assembled over a box or container bottom 20 (not visible in FIG. 3). The bending points on either of the embodiments of the handle insert 10, 50 allow for the strap 13 to be bent and folded upon itself. This folding allows the second anchoring end 12 to be brought through an opening in a box lid 30 sidewall 31 and into nesting contact with the first anchoring end 11 already in position in the box bottom sidewall opening (not visible in FIG. 3). The handle insert 10, 50 so installed secures the box lid 30 against vertical translation and the cavity 136 provides a hand-hold for providing a lifting force.

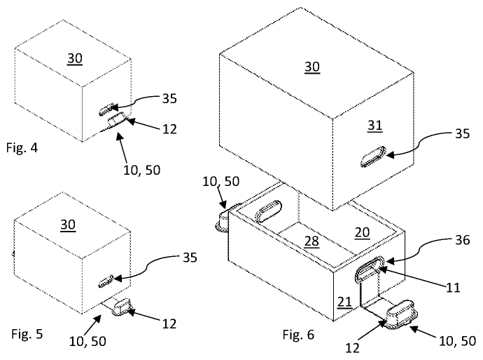

FIGS. 4, 5, and 6 illustrate various states of disassembly of the handle insert 10, 50 holding the box or container lid 30 on the box or container bottom 20. Starting with FIG. 4, the second anchoring end 12 is detached from a detachable attachment to the first anchoring end 11 through an opening 35 disposed through the sidewall 31 of the box or container lid 30. Tab 16 (see FIG. 1A) may be useful in this regard by providing a point of leverage for prying the second anchoring end 12 out of the first anchoring end 11. In FIG. 5 the second anchoring end 12 of the handle insert 10, 50 is pulled clear of the opening 35 and optionally laid flat on a floor or ground surface.

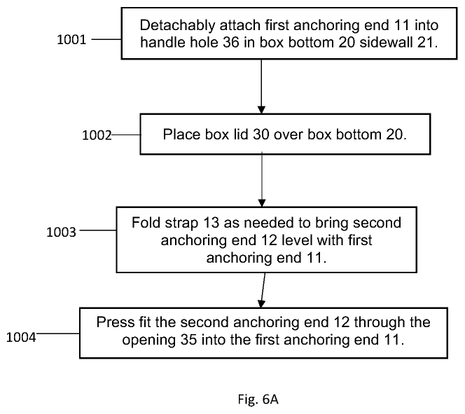

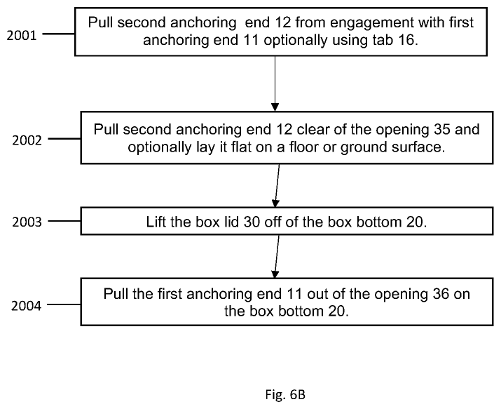

In FIG. 6 the box or container lid 30 has been translated vertically to remove it from the box or container bottom 20, revealing an interior cavity 28. In this view handle inserts 10, 50 are visible disposed within openings 36 on opposite sidewalls 21 of the box or container bottom 20. A final step in the disassembly of the handle insert 10, 50 is to simply pull the first anchoring end 11 out of the opening 36 on the box or container bottom 20.

In FIG. 6A a process for applying a handle insert 10, 50 to a box is presented. At step 1001 (see FIG. 6), the first anchoring end 11 of the handle insert 10, 50 is detachably attached into the handle hole 36 disposed through the sidewall 21 of the bottom box 20. The first anchoring end 11 may be sized to be press-fit or otherwise detachably attached through the handle hole 36. At step 1002 the box or container lid 30 is disposed on top of the box or container bottom 20 (see FIG. 5). At this point in the process a first portion of the strap 13 is behind the sidewall 31 of the box or container lid 30 and a second portion of the strap 13 remains outside of the sidewall 31.

At step 1003 the portion of the strap remaining outside of the sidewall 31 is folded as needed to bring the second anchoring end 12 level with the first anchoring end 11. If the process is utilizing a handle insert 10 then the strap 13 only needs to be folded at the living hinge 15 because the first anchoring end 11 is already in place in the opening 36 and the two sides of the strap 13 on either side of the living hinge 15 are the same length. However, if the process is utilizing a handle insert 50, then the strap 13 needs to be folded based on the height of the handle holes 35, 36.

If the strap 13 of the handle insert 50 is about twice as long as the handle height of the box handle holes 35, 36, which is the highest handle height that can be accommodated by the handle insert 50, then the strap 13 need only be folded once at the longitudinal centerline 52. If the strap 13 of the handle insert 50 is longer than twice the handle height of the box handle holes 35, 36, then the strap 13 needs to be folded three times as illustrated, for example, in FIG. 1B to bring the second anchoring end 12 level with the first anchoring end 11. Alphanumeric indicia on the strap 13, as illustrated in FIG. 1A, provide guidance for where to make the folds, with the fold of the center score 121 being directed upwardly so that the strap 13 takes on a general W shape as shown in FIG. 1B. The folding of the strap 13 for the handle insert 50 can be executed after the box lid 30 is applied, or optionally the folding of the strap 13 can be executed before the box lid 30 is applied so that the upwardly directed portion of the folded strap 13 is captured behind the sidewall 31.

At step 1004 (see FIG. 3) the second anchoring end 12 is press fit through the opening 35 into detachable engagement with the first anchoring end 11. Now the assembled box is ready to be lifted and carried away using the installed handle insert 10, 50.

A process for removal of the handle insert 10, 50 has been described hereinabove with regard to FIGS. 4-6, and in FIG. 6B steps in the process for removing the handle insert 10, 50 from a box are summarized. At step 2001, the second anchoring end 12 is pulled from engagement with the first anchoring end 11. In this regard the tab 16 is noted to be optionally used. The position of the tab 16 extending from the second anchoring end 12 makes the tab 16 useful for gaining leverage on the second anchoring end 12 when removing the second anchoring end 12 from the first anchoring end 11. In some embodiments, engagement provided by an adhesive or adhesive tape applied to one or both of the first and second anchoring ends 11, 12 must also be overcome by pulling on the second anchoring end 12.

At step 2002 the second anchoring end 12 is pulled clear of the opening 35 and optionally laid flat on the surface on which the box or container bottom 20 rests. At step 2003 the box or container lid 30 is lifted off of the box or container bottom 20. At step 2004 the first anchoring end 11 is pulled out from the opening 36 on the box or container bottom 20.

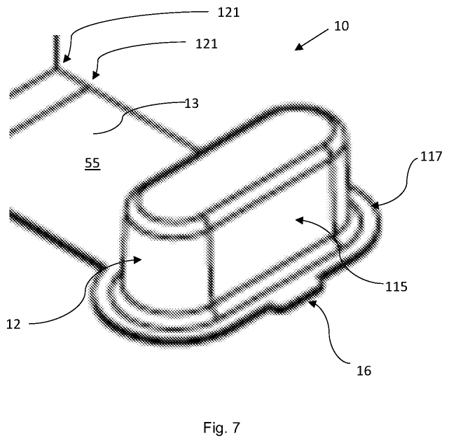

Referring to FIG. 7, in one embodiment the handle insert 10, 50 has a second anchoring end 12 (and a first anchoring end 11 not shown in this figure) that comprises a rounded and generally elongate profile having an outer surface or wall 115 wherein the second anchoring end 12 (and the first anchoring end 11 not shown in this figure) is surrounded around an open end by a lip 117. In other embodiments the shape of the first and second anchoring ends 11, 12 can comprise other shapes adapted for nesting and for insertion of one or more of a user's fingers, or as is otherwise known in the art.

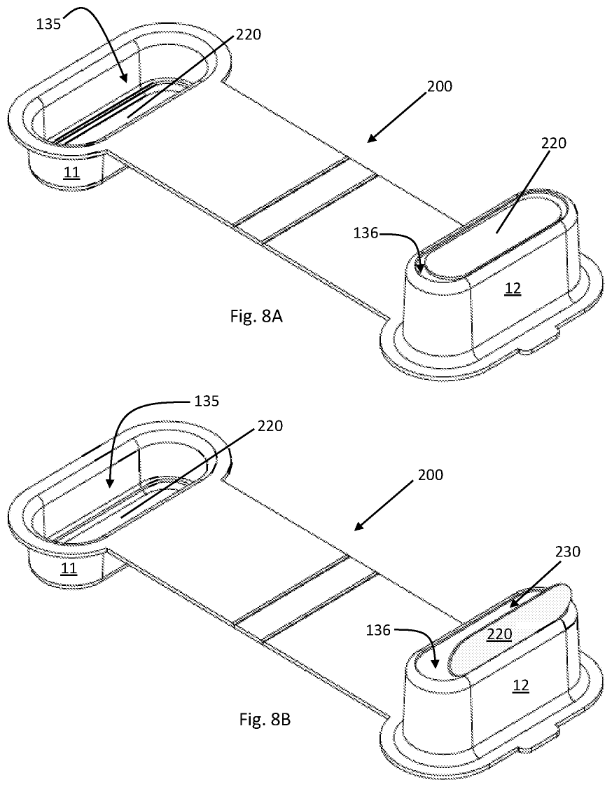

Referring to FIGS. 8A and 8B, in one embodiment of a handle insert 200 each of the first and second anchoring ends 11, 12 includes a push through flap 220 disposed at the closed end 137 of the cavity 135, 136, respectively. The flap 220 is sized to be generally about the same size as what would otherwise be the closed end 137 of each cavity 135, 136 but may be somewhat smaller as shown in FIG. 8A thereby leaving a small gap between the flap 220 and a sidewall of the cavity 135, 136. The flap 220 on each of the first and second anchoring ends 11, 12 in one embodiment comprises a strip of material integrally connected, for example without limitation by a living hinge to an edge of one of the sidewalls of the respective cavities 135, 136. In other embodiments the flap 220 is integral to or an additional component added to each of the first and second anchoring ends 11, 12 by any hinged attachment as may be known in the art. The flap 220 is shown in FIGS. 8A and 8B as part of a handle insert 200 that is otherwise identical to the handle insert 10 (see FIG. 1). It should be noted that the handle insert 200 may alternatively include the flap 220 as described herein as part of a handle insert (not shown) that is otherwise identical to the handle insert 50 (see FIGS. 1A and 2).

A user may open or close the flap 220 on each of the first and second anchoring ends 11, 12 by simply applying pressure to it to rotate it relative to a side wall of the respective cavity 135, 136, for example, with their fingers. FIG. 8A shows the flap 220 in an exemplary closed position. FIG. 8B shows the flap 220 in an exemplary open position, which creates an opening 230 through the otherwise closed end 137 of the first or second anchoring end 11 or 12 to which the flap 220 is attached. When the handle insert 200 is installed on a box, for example as described hereinabove with regard to FIG. 3, with the flap 220 on each of the first and second anchoring ends 11, 12 in the open position as shown in FIG. 8B, a user may at least partially extend their fingers through the openings 230 and therefore through the box handle holes 35, 36, for example, to provide an extra grip or leverage on the box during a lifting operation.

### INDUSTRIAL APPLICABILITY

A handle insert secures top and bottom portions of a box or container to one another while providing a point for securely applying a lifting force to the box or container. In one embodiment the handle insert can be folded to fit on boxes or containers having various handle heights. The handle insert can be made in industry for use by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

I claim:

1. A handle insert, comprising:
first and second anchoring ends connected by a strap;
wherein the first and second anchoring ends each comprise a cavity defined by a closed end and a wall that extends from a perimeter of the closed end, wherein the first and second anchoring ends are configured to detachably attach by nesting.

2. The handle insert of claim 1, wherein the strap comprises at least two grooves disposed in a surface of the strap, the at least two grooves oriented to extend laterally across the strap.

3. The handle insert of claim 2 wherein the at least two grooves comprise exactly two grooves, wherein the two grooves are about equally spaced from a longitudinal centerline of the strap.

4. The handle insert of claim 2, wherein the at least two grooves comprise more than two grooves, wherein the more than two grooves are about equally spaced apart from one another and as a group are centered on a longitudinal centerline of the strap.

5. The handle insert of claim 4, wherein the more than two grooves are each labeled with an alphanumeric indicia.

6. The handle insert of claim 1, wherein the first and second anchoring ends are configured to further detachably attach via a press fit, a snap fit, or via an adhesive disposed on one or both of the first and second anchoring ends.

7. The handle insert of claim 1 further comprising a tab that extends away from the strap from the wall of at least one of the first and second anchoring ends.

8. A handle insert, comprising:
first and second anchoring ends connected by a strap;
wherein the first and second anchoring ends each comprise a cavity defined by a closed end and a wall that extends from a perimeter of the closed end, wherein the first and second anchoring ends are configured to detachably attach by nesting; and
wherein the strap comprises at least two grooves disposed in a surface of the strap, the at least two grooves oriented to extend laterally across the strap.

9. The handle insert of claim 8, wherein the first and second anchoring ends are configured to further detachably attach via a press fit, a snap fit, or via an adhesive disposed on one or both of the first and second anchoring ends.

10. The handle insert of claim 8 wherein the at least two grooves comprise exactly two grooves, wherein the two grooves are equally spaced from a longitudinal centerline of the strap.

11. The handle insert of claim 9, wherein the at least two grooves comprise more than two grooves, wherein the more than two grooves are about equally spaced apart from one another and as a group are centered on a longitudinal centerline of the strap.

12. The handle insert of claim 11, wherein the more than two grooves are each labeled with an alphanumeric indicia.

13. A handle insert, comprising:
first and second anchoring ends connected by a strap;
wherein the first and second anchoring ends each comprise a cavity defined by a closed end and a wall that extends from a perimeter of the closed end, wherein the first and second anchoring ends are configured to detachably attach by nesting; and
wherein each of the first and second anchoring ends includes a push through flap disposed at the closed end of the cavity.

14. The handle insert of claim 13, wherein the push through flap comprises a strip of material connected by a living hinge to the wall.

15. The handle insert of claim 13, wherein the first and second anchoring ends are configured to further detachably attach via a press fit, a snap fit, or via an adhesive disposed on one or both of the first and second anchoring ends.

16. The handle insert of claim 13, wherein the strap comprises at least two grooves disposed in a surface of the strap, the at least two grooves oriented to extend laterally across the strap.

17. The handle insert of claim 16 wherein the at least two grooves comprise exactly two grooves, wherein the two grooves are equally spaced from a longitudinal centerline of the strap.

18. The handle insert of claim 16, wherein the at least two grooves comprise more than two grooves, wherein the more than two grooves are about equally spaced apart from one another and as a group are centered on a longitudinal centerline of the strap.

19. The handle insert of claim 18, wherein the more than two grooves are each labeled with an alphanumeric indicia.
